(19) United States
(12) Patent Application Publication
(10) Pub. No.: US 2026/0099481 A1
(43) Pub. Date: Apr. 9, 2026

(54) EFFICIENT MANAGEMENT OF QUEUE ENTRY STATE

(71) Applicant: NVIDIA Corporation, Santa Clara, CA (US)

(72) Inventors: Ziyad Hakura, San Jose, CA (US); Yury Uralsky, Los Gatos, CA (US); Kedar Shripad Joglekar, Pune (IN); Hao Zhang, Tokyo (JP); Sriram Venkateshan, Bengaluru (IN); Henry Moreton, Woodside, CA (US)

(21) Appl. No.: 19/185,635

(22) Filed: Apr. 22, 2025

Related U.S. Application Data
(60) Provisional application No. 63/704,279, filed on Oct. 7, 2024.

(51) Int. Cl. G06F 16/22; G06F 9/54

(52) U.S. Cl. CPC G06F 16/2272; G06F 9/546; G06F 2209/548

(57) ABSTRACT

Disclosed are systems and techniques for tracking the state of entries in a queue. The techniques include providing a first entry of a queue to a first process and providing a second entry of the queue to a second process. The queue includes a plurality of segments. The techniques further include, responsive to receiving a first signal from the first process, modifying a data structure associated with the queue for the first entry. The data structure associated with the queue includes a plurality of sections. Each section includes one or more counters each associated with a segment of the plurality of segments. The techniques further include, responsive to receiving a second signal from the second process, modifying the data structure associated with the queue for the second entry. The techniques further include modifying a tail pointer of the queue based on the data structure associated with the queue.

### CROSS-REFERENCE TO RELATED APPLICATIONS

This application claims the benefit of priority to provisional Ser. No. 63/704,279, filed Oct. 7, 2024, which is hereby incorporated by reference in its entirety.

### TECHNICAL FIELD

At least one embodiment pertains to managing entries in a queue, and more specifically to using metadata to track state of the entries in the queue.

### BACKGROUND

Parallel processing units, such as graphics processing units, can execute multiple tasks in parallel. In some cases, the tasks to be executed by the parallel processing unit can be expressed as a graph of nodes. Each node can represent a unit of work to be executed on the parallel processing unit. The nodes can have dependencies on other nodes, which can indicate an order of execution and control the flow of data between nodes. Producer nodes can produce data that is used by consumer nodes. In some cases, a node can be both a consumer node (e.g., can use data produced by a previous node in the graph) and a producer node (e.g., can create data that is used by a next node in the graph). In some cases, the data from a producer node can be stored in a queue associated with the consumer node. In some cases, multiple producer nodes can store data in the same queue for a particular consumer node. In some cases, multiple consumer nodes can use data from the same queue.

### BRIEF DESCRIPTION OF THE DRAWINGS

FIG. 1 is a block diagram of an example system for tracking the state of entries in a queue, according to at least one embodiment.

FIG. 2 is a block diagram of an example queue of entries, according to at least one embodiment.

FIG. 3 is a block diagram of an example queue with adjacent entries in different states, according to at least one embodiment.

FIG. 4A is a block diagram of an example queue as entries are being consumed, according to at least one embodiment.

FIG. 4B is a block diagram of an example queue as entries are being consumed, according to at least one embodiment.

FIG. 4C is a block diagram of an example queue as entries are being consumed, according to at least one embodiment.

FIG. 4D is a block diagram of an example queue as entries are being consumed, according to at least one embodiment.

FIG. 5A is a block diagram of a bit array data structure for tracking the state of queue entries, according to at least one embodiment.

FIG. 5B is a block diagram of a bit array data structure for tracking the state of queue entries, according to at least one embodiment.

FIG. 6 is a block diagram of a bit array data structure for tracking the state of queue entries, according to at least one embodiment.

FIG. 7A is a block diagram of a segmented bit queue data structure for tracking the state of queue entries, according to at least one embodiment.

FIG. 7B is a block diagram of a segmented bit queue data structure for tracking the state of queue entries, according to at least one embodiment.

FIG. 8A is a block diagram of a segmented bit queue data structure for tracking the state of queue entries that can be “partially deallocated,” according to at least one embodiment.

FIG. 8B is a block diagram of a “partially deallocated” segmented bit queue data structure for tracking the state of queue entries, according to at least one embodiment.

FIG. 9 is a flow diagram of an example method for tracking the state of entries in a queue, according to at least one embodiment.

FIG. 10 is a block diagram illustrating an exemplary computer system, in accordance with at least one embodiment of the present disclosure.

FIG. 11A illustrates inference and/or training logic, according to at least one embodiment of the present disclosure.

FIG. 11B illustrates inference and/or training logic, according to at least one embodiment.

FIG. 12 illustrates training and deployment of a neural network, according to at least one embodiment.

FIG. 13 is an example data flow diagram for an advanced computing pipeline, according to at least one embodiment.

FIG. 14 is a system diagram for an example system for training, adapting, instantiating and deploying machine learning models in an advanced computing pipeline, according to at least one embodiment.

### DETAILED DESCRIPTION

It can be advantageous to track a state of the entries in a queue of a consumer node. For example, at a first time, a producer node may allocate space within the queue for a new entry. The entry may not be populated by the producer node and ready for consumption by the consumer node until a second time. On the consumer side, an entry of the queue may be ready for consumption but may not yet be consumed by the consumer node. Once a particular entry has been consumed, it may be eligible to be cleared from the queue (e.g., deallocated), but there can be some time between the entry becoming ready for deallocation and actually deallocating the entry.

One or more pointers can be used to indicate where to allocate memory for new entries in the queue, which entries have been produced and are ready for consumption, which entries have been consumed and are ready for deallocation, which entries have been deallocated already, etc. In some cases, entries of the queue can be ready for consumption and/or consumed out of order compared to neighboring entries in the queue. To prevent data corruption or memory leaks, it can be important to only update pointers associated with the queue when all of the entries between the old pointer position and the new pointer position have been taken care of (e.g., produced entries are actually ready for consumption, consumed entries are ready for deallocation, etc.). This out-of-order behavior can make it difficult to update the pointers associated with the queue and can require storing additional metadata about the queue and its entries.

Aspects of the present disclosure address the above and other deficiencies by providing for systems and techniques to track the state of entries in a queue and manage the allocation and deallocation of the memory related to entries in the queue. In some embodiments, the queue has a first head pointer and a first tail pointer associated with the producer side of the queue and a second head pointer and a second tail pointer associated with the consumer side of the queue. In some embodiments, a data structure can be associated with the queue for storing metadata about the queue and its entries. In some embodiments, more than one data structure can be associated with the queue. For example, there may be a first data structure for the producer side of the queue and a second data structure for the consumer side of the queue.

In a first embodiment, a data structure associated with the queue can include a maximum index and a current index. The data structure may be associated with one side of the queue (e.g., the producer side or the consumer side). The head pointer of the queue can be advanced when new entries are allocated for the queue (e.g., on the producer side) or when entries are provided for consumption (e.g., on the consumer side). For example, two entries may be ready for consumption, and the head pointer may be advanced over the entries. The entries may be provided to a processor (e.g., a parallel processing unit) for execution. In some embodiments, the entries may be provided to the same processor, different threads of the same processor, different processors, etc. Once each entry has been used (e.g., once the processor no longer needs to access a particular entry), the data structure associated with the queue can be updated.

In the first embodiment, after an entry has been consumed, the maximum index of the data structure may be updated based on an index within the queue of the consumed entry. For example, if the index of the consumed entry is larger than the current maximum index value of the data structure, the maximum index value may be modified to equal the index of the consumed entry. If the index of the consumed entry is less than or equal to the current maximum index value of the data structure, the maximum index value may not be modified.

Additionally, the current index value of the data structure may be incremented for each entry that has been consumed. When the current index value of the data structure matches the maximum index value of the data structure, that is an indication that all the entries between the current position of the tail pointer and the maximum index value are ready to be deallocated, and the tail pointer of the queue can be safely advanced to equal the maximum index value.

In a second embodiment, a data structure associated with the queue can include a bit array with one or more bits corresponding to indices in the queue. For example, each index in the queue can have a corresponding bit in the bit array. In some embodiments, the bit array can be divided into one or more sections, each section having a tail indicator bit and a plurality of index bits (e.g., bits corresponding to indices in the queue). In some embodiments, a single bit array data structure can be used for a whole queue (e.g., the producer side of the queue and the consumer side of the queue can use the same bit array data structure). In such a case, each set of head and tail pointers (e.g., producer-side head and tail pointers, consumer-side head and tail pointers, etc.) can indicate that a record is “ready” (e.g., ready to be consumed, ready to be deallocated, etc.) using opposite bit values. For example, on the producer side, bit values of 1 may indicate that a record is ready to be consumed, and on the consumer side, bit values of 0 may indicate that a record is ready to be deallocated. In some embodiments, bit values of 0 may indicate that a record is ready to be consumed, and bit values of 1 may indicate that a record is ready to be deallocated. Bit values may be “flipped” (e.g., perform an exclusive-OR (XOR) operation) to indicate they are “ready” (e.g., ready to be consumed, ready to be deallocated, etc.).

The producer-side head pointer can be advanced to point to a new entry in the bit array data structure when new entries are allocated for the queue. Once the new entry in the queue is ready to be consumed, the bit value in the bit array data structure corresponding to the queue entry may be “flipped.” The producer-side tail pointer may advance over a consecutive run of bit array entries that have a bit value indicating the corresponding data entry is ready to be consumed (e.g., a bit value of “1”).

The consumer-side head pointer may advance over one or more bit array entries that are ready to be consumed (e.g., have a bit value set to “1” in the data structure). Once a queue entry has been consumed and is ready for deallocation, the bit value in the bit array data structure corresponding to the queue entry that was consumed may be flipped. The consumer-side tail pointer may advance over a consecutive run of bit array entries that have a bit value indicating that the corresponding data entry is ready to be deallocated (e.g., a bit value of “0”).

In a third embodiment, the queue can be divided into segments, and a data structure associated with the queue can include a plurality of sections. Each section of the data structure can include one or more counters, with each counter corresponding to a segment of the queue. In some embodiments, each section also includes one or more tail indicator bits and local tail position bits. The data structure may be associated with one side of the queue (e.g., the producer side or the consumer side).

The producer-side head pointer can be advanced to point to a new entry in the queue when allocating memory for the new entry. The new entry can be associated with a particular segment of the queue. Once the new entry in the queue is ready to be consumed, a counter associated with the new entry's segment can be incremented within the data structure associated with the queue. The counter can be contained within a section of the data structure. Once the counter reaches a threshold value, the producer-side tail pointer can be advanced over the entire segment of the queue associated with the counter.

Similarly on the consumer-side, the consumer-side head pointer can be advanced to point to a new entry in the queue when the entry is provided to a consumer process. The entry can be associated with a particular segment of the queue. Once the entry has been consumed and is ready to be deallocated, a counter associated with the entry's segment can be incremented within the data structure associated with the queue. The counter can be contained within a section of the data structure. Once the counter reaches a threshold value, the consumer-side tail pointer can be advanced over the entire segment of the queue associated with the counter.

In some embodiments, if the head pointer and the tail pointer of a particular side of the queue are in the same segment of the queue, the tail pointer can be partially advanced through the segment to prevent deadlocks. In some embodiments, to prevent the head pointer from wrapping around queue to point to the same segment as the tail pointer, an initial gap can be introduced between the head pointer and the tail pointer to ensure the head pointer stays at least one segment length behind the tail pointer.

Advantages of the disclosed embodiments over the existing technology include but are not limited to efficient memory management and launching of parallel processing tasks.

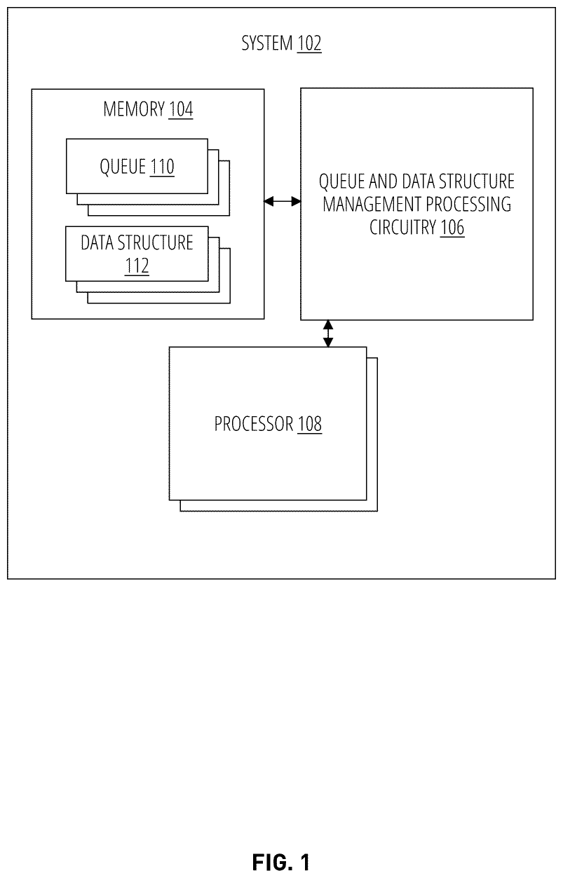

FIG. 1 is a block diagram of an example system 102 for tracking the state of entries in a queue, according to at least one embodiment. System 102 can include memory 104 and one or more processors 108. Memory 104 can include read-only memory (ROM), flash memory, dynamic random access memory (DRAM), such as synchronous DRAM (SDRAM), double data rate (DDR SDRAM), or DRAM (RDRAM), and/or the like. Processors 108 can include one or more processing units, such as central processing units (CPUs), graphics processing units (GPUs), data processing units (DPUs), parallel processing units, accelerators, physics processing units (PPUs), etc. Memory 104 and processors 108 may be connected via queue and data structure management processing circuitry 106.

System 102 can be used to execute work defined in a graph of nodes. Each node can represent a unit of work to be executed by one or more processors 108 of system 102. The nodes can have dependencies on other nodes, which can indicate an order of execution and control the flow of data between nodes. Producer nodes can produce data that is used by consumer nodes. In some cases, the data from a producer node can be stored in a queue associated with the consumer node. The queues associated with each node may be stored in memory 104 by queue and data structure management processing circuitry 106. Memory 104 may also include data structures 112 associated with queues 110 for tracking states of the entries within queues 110.

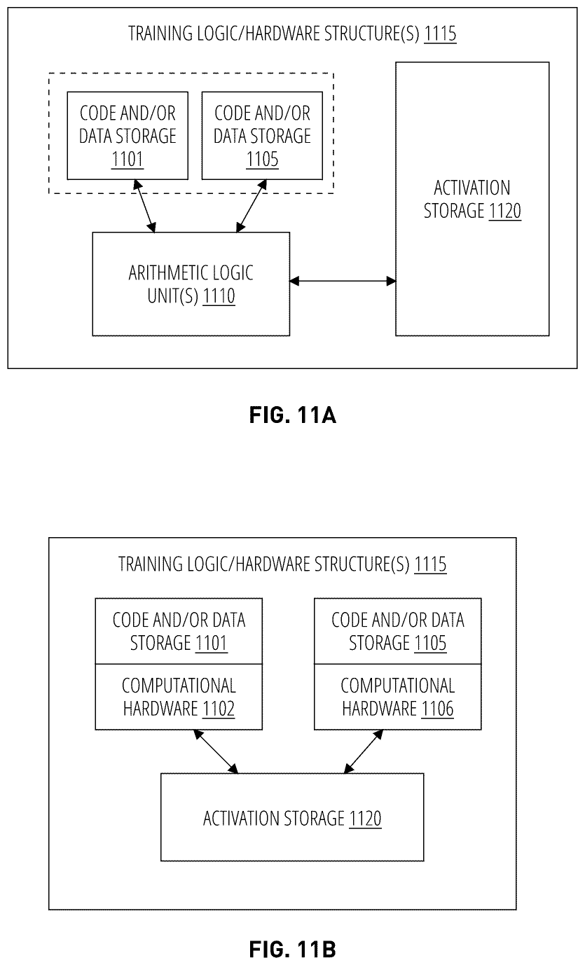

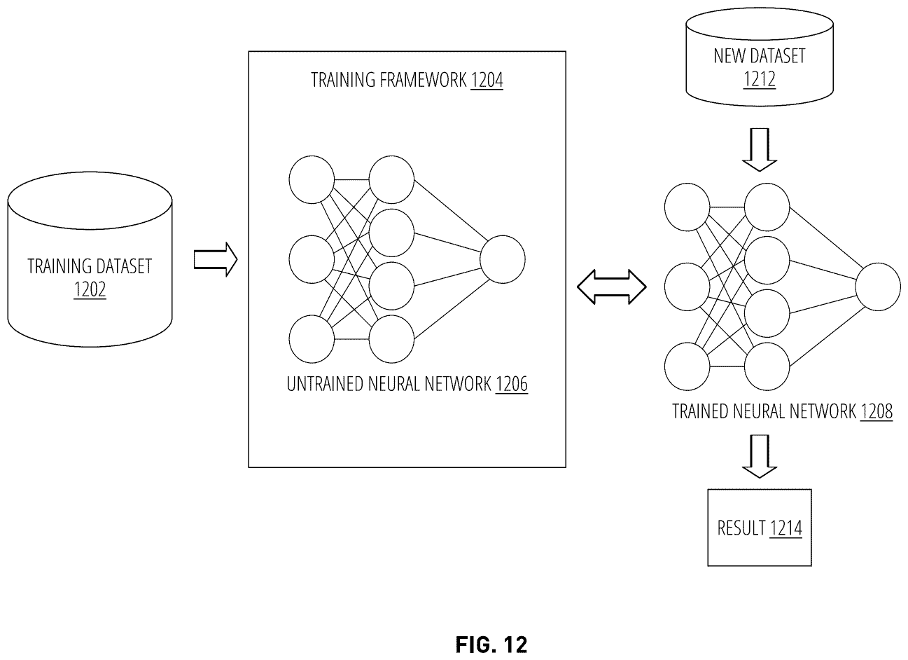

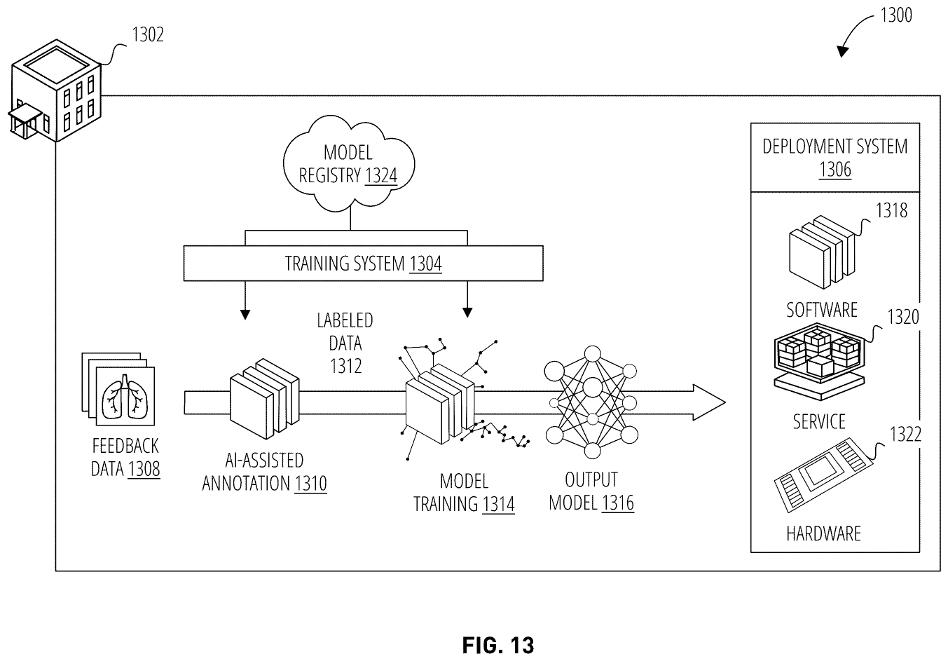

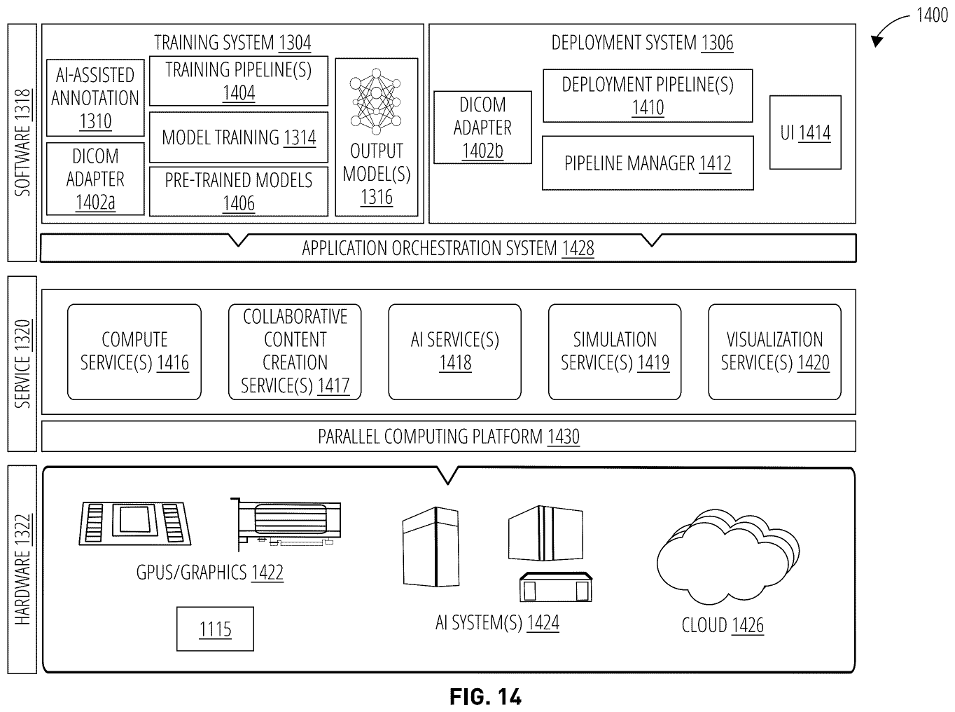

In some embodiments, the work defined in the graph of nodes is graphics rendering work. In some embodiments, the work defined in the graph of nodes is artificial intelligence and/or machine learning work, such as training an artificial intelligence model and/or performing inference on an artificial intelligence model. Training and use of artificial intelligence models may be described in more detail with regard to FIG. 11A, FIG. 11B, FIG. 12, FIG. 13, and FIG. 14.

As an example of a simple work graph, a first node (e.g., a producer node) may be executed by a first processor of processors 108 (or by a first thread of a processor). During execution, the first processor may signal queue and data structure management processing circuitry 106 to allocate memory for a new entry on a queue 110 associated with a particular consumer node. Memory may be allocated for the entry, and the first processor may cause data to be stored in the queue entry during execution of the first node. Once all the data has been stored in the queue entry (e.g., once the data is ready to be consumed by a second node), the first processor may provide a signal to queue and data structure management processing circuitry 106. Queue and data structure management processing circuitry 106 may update a data structure 112 associated with the queue 110 to indicate that the new entry is ready to be consumed, as described in more detail below.

A second node (e.g., a consumer node) may be executed by a second processor of processors 108 (or by a second thread of the first processor). During execution, the second processor may signal queue and data structure management processing circuitry 106 to request data stored in a queue entry associated with the consumer node. Queue and data structure management processing circuitry 106 may update a data structure 112 associated with the queue 110 to indicate that the entry is being consumed. After the second node is finished using the data stored in the entry, the second processor may provide a signal to queue and data structure management processing circuitry 106, and queue and data structure management processing circuitry 106 may update the data structure 112 associated with the queue 110 to indicate that the memory associated with the entry is available to be deallocated.

Each queue 110 may include one or more head pointers and tail pointers for keeping track of entries within the queue. Queue and data structure management processing circuitry 106 may modify the head and tail pointers as entries are allocated, produced, consumed, and deallocated. Queue and data structure management processing circuitry 106 may track additional state associated with each queue 110 and its entries in a data structure 112 associated with the queue.

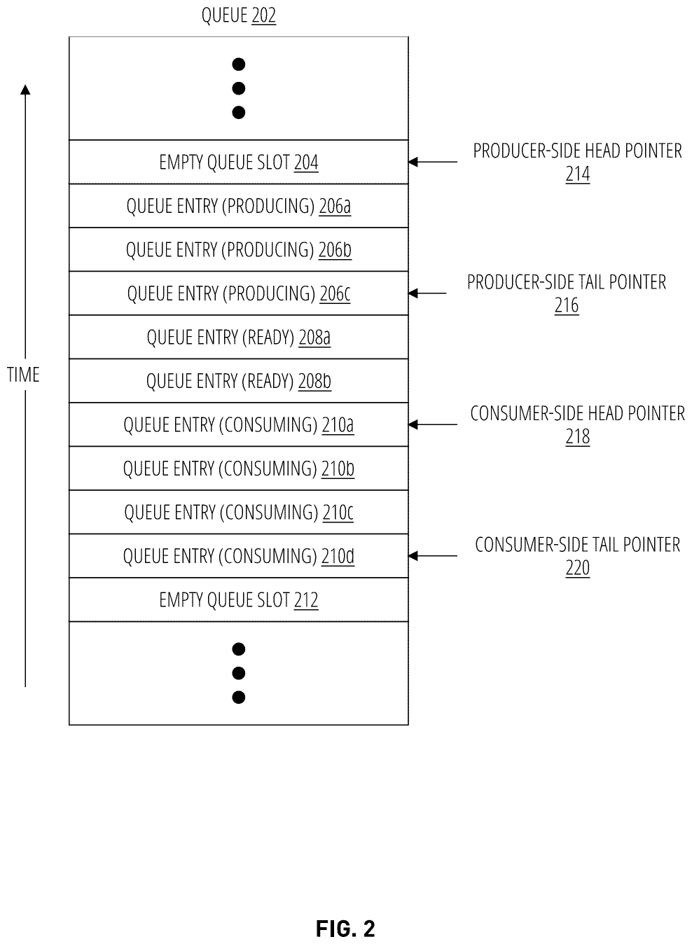

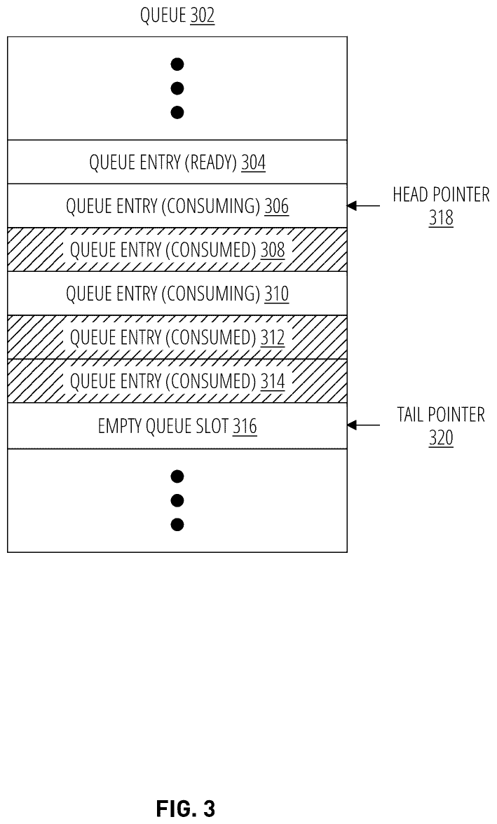

FIG. 2 is a block diagram of an example queue 202 of entries, according to at least one embodiment. Queue 202 can be stored in a memory (e.g., memory 104 of FIG. 1) and, in some embodiments, may be a circular queue. Queue 202 can include empty entries (e.g., empty queue slot 204, empty queue slot 212, etc.), entries that have been allocated but are not ready to be read from yet (e.g., queue entry (producing) 206a, queue entry (producing) 206b, queue entry (producing) 206c, etc.), entries that are ready to be consumed (e.g., queue entry (ready) 208a, queue entry (ready) 208b), entries that are being consumed (e.g., queue entry (consuming) 210a, queue entry (consuming) 210b, queue entry (consuming) 210c, queue entry (consuming) 210d, etc.), and entries that have been consumed and are ready to be deallocated, as seen in FIG. 3.

One or more pointers can be associated with queue 202 to keep track of the entries.

One side of the queue can be associated with producer nodes and can have a producer-side head pointer and a producer-side tail pointer. For example, producer-side head pointer 214 can indicate where the next entry within the queue is to be allocated (e.g., the next entry may be stored in empty queue slot 204). Producer-side tail pointer 216 can indicate which entries are being produced and are not yet ready to be consumed. For example, entries before producer-side tail pointer 216 may not be ready for consumption while entries after producer-side tail pointer 216 may be ready to be consumed.

The other side of the queue can be associated with consumer nodes and can have a consumer-side head pointer and a consumer-side tail pointer. For example, consumer-side head pointer 218 can indicate which entries are currently being consumed by one or more consumer nodes. Consumer-side tail pointer 220 can indicate which entries have been consumed and are ready to be deallocated. For example, entries before consumer-side tail pointer 220 may not be ready for deallocation while entries after consumer-side tail pointer 220 are ready to be deallocated.

In some cases, empty queue slot 212 previously stored data, was consumed by one or more consumer nodes, and was deallocated after being consumed.

Because the tail pointer acts as a boundary between “producing” and “produced” entries and between “consuming” and “consumed” entries, it can only advance over entries that have all been “produced” or “consumed,” as will be described in more detail below in FIG. 3.

A data structure associated with queue 202 can keep track of the state of the entries within the queue and can indicate when a tail pointer (e.g., a producer-side tail pointer, a consumer-side tail pointer, etc.) can be advanced over entries of the queue.

FIG. 3 is a block diagram of an example queue 302 with adjacent entries in different states, according to at least one embodiment. Queue 302 can include one or more “ready” entries (e.g., queue entry (ready) 304) that are ready to be consumed by a consumer node but that have not yet been provided to a consumer node (e.g., to a node being processed by a processor).

Queue 302 can include one or more “consuming” entries (e.g., queue entry (consuming) 306, queue entry (consuming) 310) that have been provided to a consumer node and are currently being used. For example, an entry is a “consuming” entry if a node being processed by a processor is currently or will access the data stored in the entry.

Queue 302 can include one or more “consumed” entries (e.g., queue entry (consumed) 308, queue entry (consumed) 312, queue entry (consumed) 314) that have been provided to a consumer node and are no longer being used. For example, an entry is a “consumed” entry if a node being processed by a processor previously accessed the data stored in the entry but no longer needs to access the data. In some cases, the node has finished being processed. In some cases, the node is still being processed but does not need to access the data of the entry anymore.

Queue 302 can also include one or more empty slots (e.g., empty queue slot 316). In some cases, empty queue slot 316 previously stored data and was deallocated because it was already consumed by a consumer node.

Head pointer 318 can indicate which entries have already been provided to a consumer node. When another consumer node begins execution, head pointer 318 can advance to queue entry (ready) 304 and provide it to the consumer node, changing queue entry (ready) 304 from “ready” to “consuming.”

Each entry of queue 302 can be provided to and/or processed by a different processor in parallel. Each entry of queue 302 can also store a different amount of data and/or have a different size. As such, one entry of queue 302 may be consumed quickly after being provided to a processor while another entry of queue 302 takes more time to be consumed. This can result in entries that have different states as compared to their surrounding entries.

For example, queue entry (consumed) 308 has already been consumed while queue entry (consuming) 306 and queue entry (consuming) 310 are still being consumed. As mentioned previously, tail pointer 320 can only advance over entries that have already been consumed. In this case, tail pointer 320 can advance over queue entry (consumed) 314 and queue entry (consumed) 312. However, tail pointer 320 cannot move to queue entry (consumed) 308 because queue entry (consuming) 310 is still being consumed. Once queue entry (consuming) 310 switches from “consuming” to “consumed,” tail pointer 320 can advance over queue entry (consuming) 310 and queue entry (consumed) 308.

Queue 302 depicts a consumer-side of a queue, but it should be understood that a producer-side of the queue operates similarly. The queue can include “empty slots” where new entries can be allocated, “producing entries” (e.g., entries that have been allocated and are currently having data stored in them), and “produced entries” (e.g., entries that have been written to and are ready to be consumed). In some cases, the “produced entries” of the producer-side of the queue are equivalent to the “ready” entries of the consumer-side of the queue.

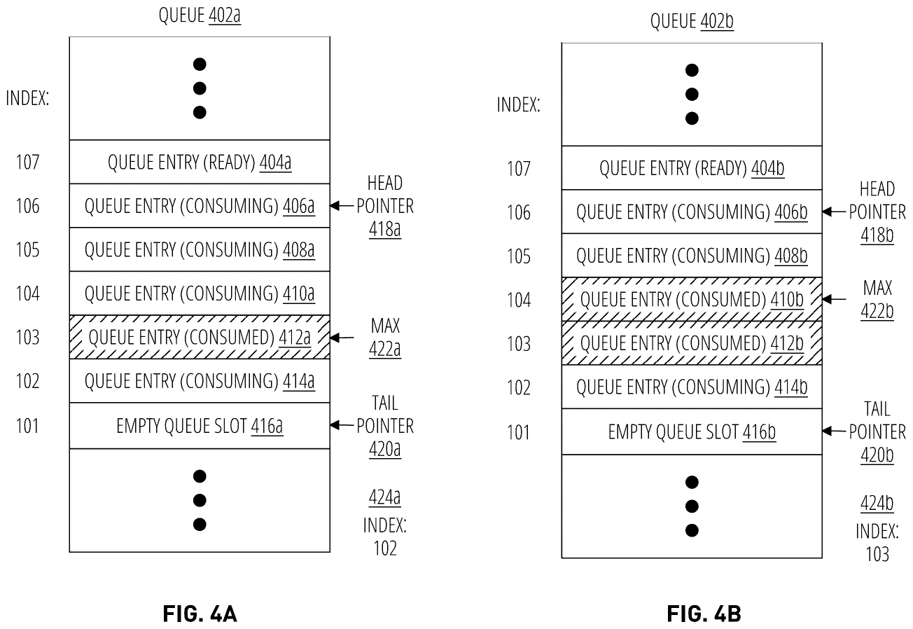

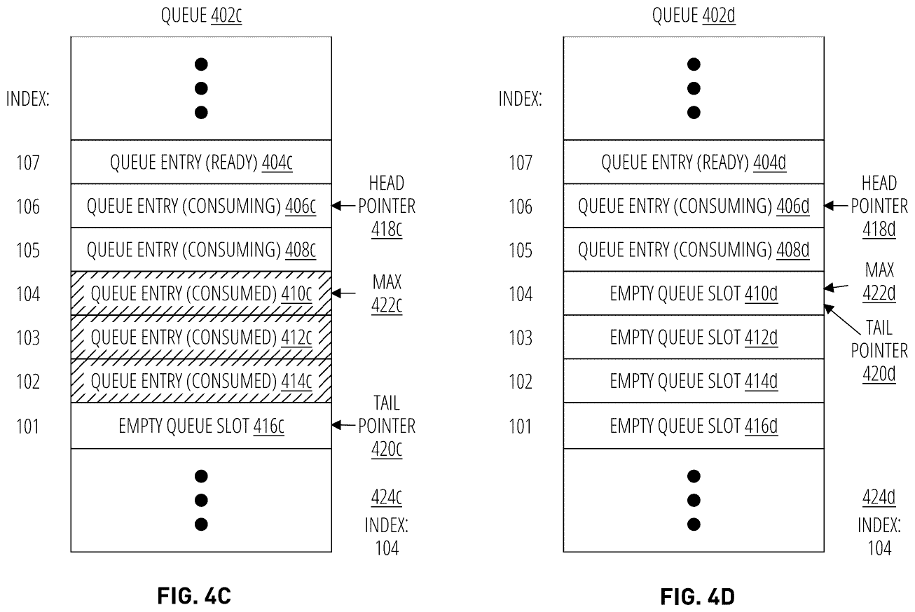

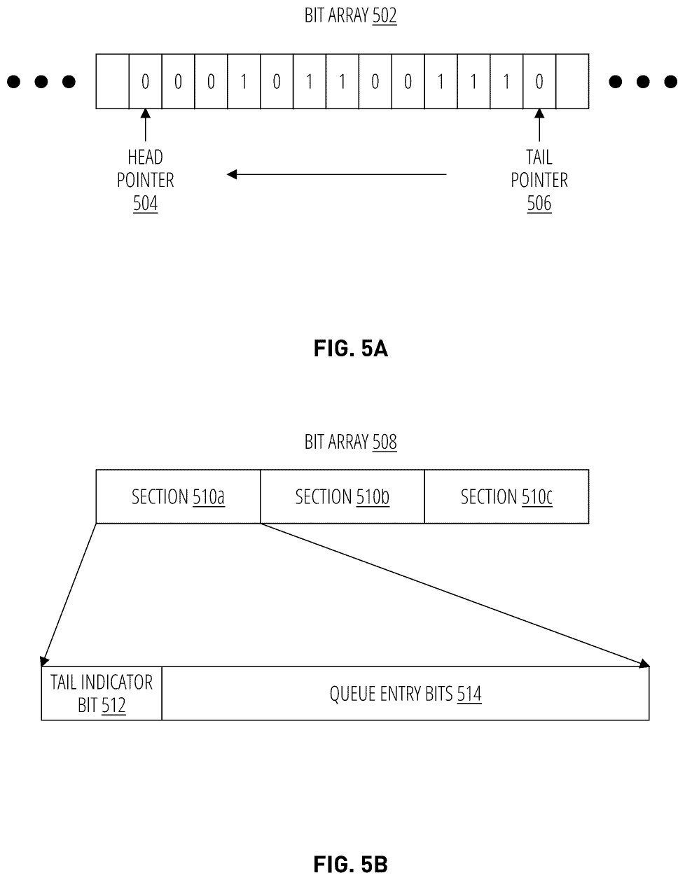

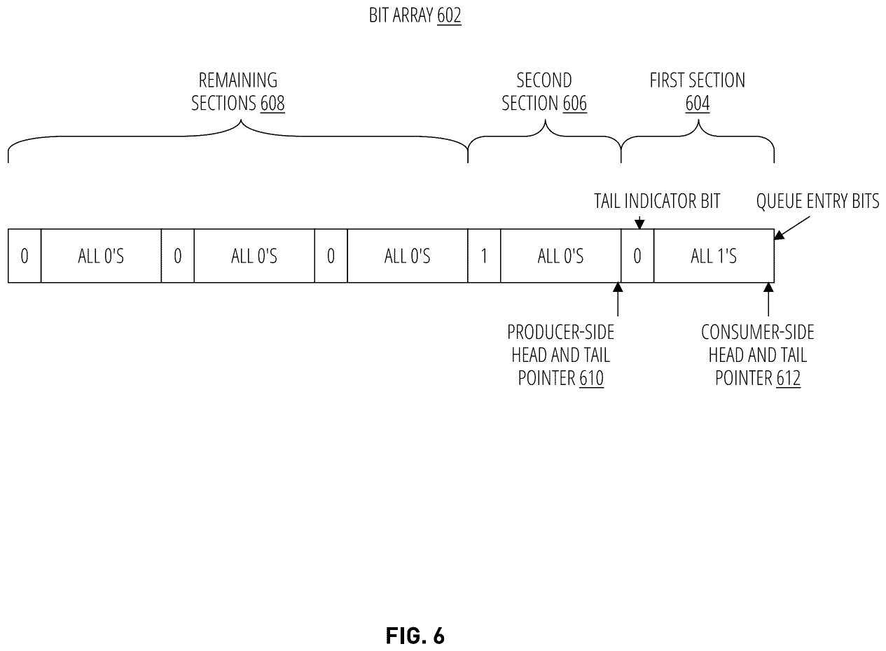

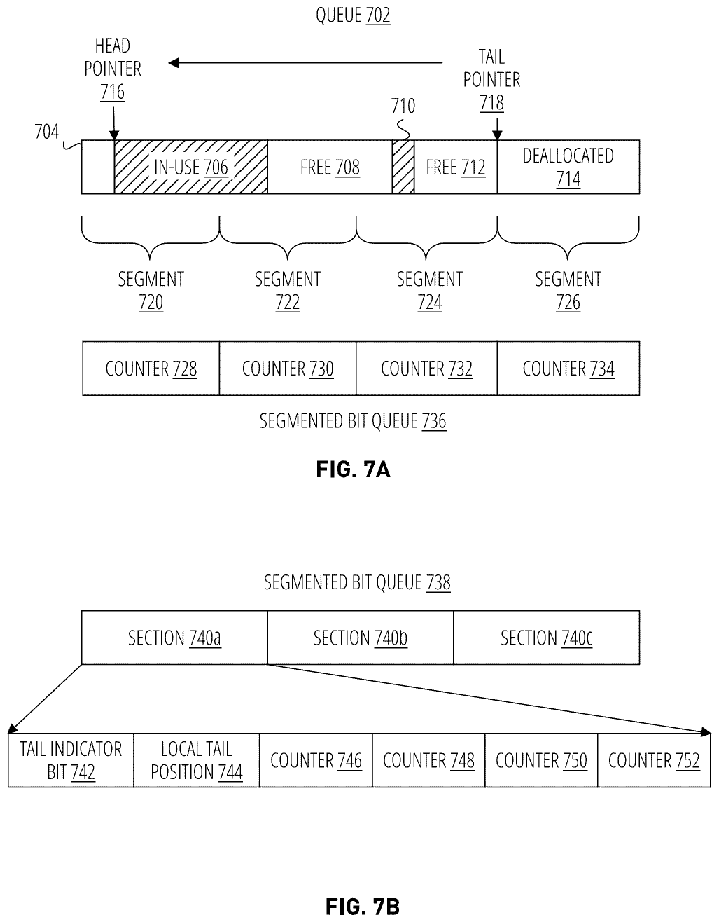

The following figures describe different data structures that can be used for keeping track of the state of entries in a queue. FIG. 4A-FIG. 4D depict a first “maximum+index” data structure. FIG. 5A, FIG. 5B, and FIG. 6 depict a second “bit array” data structure.” FIG. 7A and FIG. 7B depict a third “segmented bit queue” data structure.

FIG. 4A is a block diagram of an example queue 402a as entries are being consumed, according to at least one embodiment. Queue 402a has an associated data structure that tracks a “maximum index” of consumed nodes (e.g., max 422a) and a “current index” of consumed nodes (e.g., index 424a).

Similar to queue 302 of FIG. 3, queue 402a includes a plurality of entries: queue entry (ready) 404a, queue entry (consuming) 406a, queue entry (consuming) 408a, queue entry (consuming) 410a, queue entry (consumed) 412a, queue entry (consuming) 414a, and empty queue slot 416a. Head pointer 418a of queue 402a points to queue entry (consuming) 406a at index 106, indicating that entries lower than index 106 have been provided to consumer nodes already.

As shown in FIG. 4A, queue entry (consumed) 412a has already been consumed. When the processor executing the consumer node that consumed queue entry (consumed) 412a finished consuming queue entry (consumed) 412a, it may have provided a signal that modified the data structure associated with queue 402a. For example, max 422a may represent the maximum index tracked by the data structure associated with queue 402a. Before queue entry (consumed) 412a finished being consumed, max 422a may have been equal to index 101 and may have pointed to the same entry as tail pointer 420a.

When queue entry (consumed) 412a finished being consumed, max 422a may have been updated based on the index of queue entry (consumed) 412a. For example, the current value of max 422a (e.g., 101) may have been compared to the index of queue entry (consumed) 412a (e.g., 103), and the maximum index value between the two (e.g., 103) may have been stored in max 422a.

At the same time, when queue entry (consumed) 412a finished being consumed, index 424a may have been incremented by one, from its previous value of index 101 to its current value, as depicted in FIG. 4A, of index 102.

When max 422a is equal to index 424a, that indicates that all the entries between tail pointer 420a and max 422a have been consumed and it is safe to advance tail pointer 420a.

Because max 422a is equal to index 103 and index 424a is equal to index 102, tail pointer 420a may not be advanced.

FIG. 4B is a block diagram of an example queue 402b as entries are being consumed, according to at least one embodiment. Queue 402b may be the same as queue 402a but at a future time. Queue 402b may include a plurality of entries: queue entry (ready) 404b, queue entry (consuming) 406b, queue entry (consuming) 408b, queue entry (consumed) 410b, queue entry (consumed) 412b, queue entry (consuming) 414b, and empty queue slot 416b.

As compared to queue 402a, queue entry (consumed) 410b has changed from “consuming” to “consumed.” When the processor that was consuming queue entry (consumed) 410b finished accessing the data in queue entry (consumed) 410b, it may have caused the data structure associated with queue 402b to be updated. More specifically, index 424b may have been incremented by 1 from index 102 to index 103. Additionally, the index of queue entry (consumed) 410b (e.g., 104) may have been compared to max 422b (e.g., 103). Because the index of queue entry (consumed) 410b was greater than the value of max 422b, max 422b may have been updated to equal index 104.

Because max 422b still does not equal index 424b, tail pointer 420b may still point to index 101. Head pointer 418b may not be modified and may continue to point to index 106.

FIG. 4C is a block diagram of an example queue 402c as entries are being consumed, according to at least one embodiment. Queue 402c may be the same as queue 402b but at a future time. Queue 402c may include a plurality of entries: queue entry (ready) 404c, queue entry (consuming) 406c, queue entry (consuming) 408c, queue entry (consumed) 410c, queue entry (consumed) 412c, queue entry (consumed) 414c, and empty queue slot 416c.

As compared to queue 402b, queue entry (consumed) 414c has changed from “consuming” to “consumed.” When the processor that was consuming queue entry (consumed) 414c finished accessing the data in queue entry (consumed) 414c, it may have caused the data structure associated with queue 402c to be updated. More specifically, index 424c may have been incremented by 1 from index 103 to index 104. Additionally, the index of queue entry (consumed) 414c (e.g., 102) may have been compared to max 422c (e.g., 103). Because the index of queue entry (consumed) 414c is less than the value of max 422c, max 422c may not have been updated and may still equal 104.

Head pointer 418c may continue to point to index 106. However, because max 422c now equals index 424c, tail pointer 420c can be advanced to index 104, as shown in FIG. 4D.

FIG. 4D is a block diagram of an example queue 402d as entries are being consumed, according to at least one embodiment. Queue 402d may be the same as queue 402c but at a future time. Queue 402d may include a plurality of entries: queue entry (ready) 404d, queue entry (consuming) 406d, queue entry (consuming) 408d, empty queue slot 410d, empty queue slot 412d, empty queue slot 414d, and empty queue slot 416d. Head pointer 418d may continue to point to index 106.

As compared to queue 402c, empty queue slot 410d, empty queue slot 412d, and empty queue slot 414d have changed from “consumed” to “empty.” Because max 422d was equal to index 424d, it was safe to advance tail pointer 420d to index 104 and the entries at indexes 102-104 could be deallocated.

This process may continue as additional entries are provided for consumption and are consumed, with the maximum index being updated as entries are consumed and the current index being incremented for each consumed entry. In some embodiments, a very large (e.g., 64-bit) value can be used to track the queue index, maximum index, and the current index to prevent needing to wrap around the queue and perform modular arithmetic.

In some embodiments, instead of tracking a current index, a count of consumed records can be tracked (e.g., a “maximum+count” data structure). For example, as entries are consumed, the maximum index can be determined as described above, and a count of consumed records can be incremented. When the count of consumed records added to the tail pointer equals the maximum index, the tail pointer can be safely advanced to the maximum index.

In some embodiments, the signals of more than one consumer node can be combined and the data structure can be updated once for the multiple consumer nodes. For example, a first consumer node and a second consumer node may finish consuming their respective queue entries at (nearly) the same time. One of the processors associated with the consumer nodes may provide a signal to update the data structure associated with the queue that increments the current index value by 2 instead of 1 and includes the maximum index value of the two entries that are done being consumed. The other processor may not need to provide a signal.

In some embodiments, multiple processors may access the same entry of a queue. In such a case, the entry may include a number of processors that need to access the entry. As processors finish accessing the entry, the number of processors that need to access the entry may be decreased (e.g., decremented). Once the last processor finishes accessing the entry, it may provide the signal that updates the data structure associated with the queue.

Although the consumer side of a queue has been discussed in FIG. 4A, FIG. 4B, FIG. 4C, and FIG. 4D, it should be understood that similar processes can occur with respect to the producer side of the queue. For example, the producer side of the queue may have its own head pointer, tail pointer, maximum index value, and current index value.

FIG. 5A is a block diagram of a bit array data structure 502 for tracking the state of queue entries, according to at least one embodiment. Bit array 502 can include one or more bits corresponding to indices in the queue. For example, each index in the queue can have a corresponding bit in bit array 502. In some embodiments, a single bit array data structure can be used for a whole queue (e.g., the producer side of the queue and the consumer side of the queue can use the same bit array data structure). In such a case, each set of head and tail pointers (e.g., producer-side head and tail pointers, consumer-side head and tail pointers, etc.) can indicate that a record is “ready” (e.g., ready to be consumed, ready to be deallocated, etc.) using opposite bit values. For example, on the producer side, bit values of 1 may indicate that a record is ready to be consumed, and on the consumer side, bit values of 0 may indicate that a record is ready to be deallocated. In some embodiments, bit values of 0 may indicate that a record is ready to be consumed, and bit values of 1 may indicate that a record is ready to be deallocated. Bit values may be “flipped” (e.g., perform an exclusive-OR (XOR) operation) to indicate they are “ready”(e.g., ready to be consumed, ready to be deallocated, etc.).

For example, bit array 502 can include a plurality of bit values corresponding to entries in a queue. FIG. 5A may depict a portion of bit array 502. Specifically, FIG. 5A may depict head and tail pointers of one side of the queue. For example, head pointer 504 may be a producer-side head pointer, and tail pointer 506 may be a producer-side tail pointer. The 0 bit values in bit array 502 may indicate queue entries that have been allocated and are currently being filled (e.g., “producing” entries). The 1 bit values in bit array 502 may indicate queue entries that have been allocated, are already filled, and are ready to be consumed (e.g., “produced” entries). As we saw previously, entries can change state independent of neighboring entries, such that some entries are ready to be consumed while neighboring entries are still being produced.

When an entry changes from “producing” to “produced,” the processor executing the producer node corresponding to the entry may provide a signal that causes a bit corresponding to the entry to be flipped in bit array 502. After the bit is flipped, bit array 502 may be evaluated for continuous runs of the same bit value at tail pointer 506. For example, as depicted in FIG. 5A, tail pointer 506 is pointing at a 0 bit value and there are 3 1 bit values to the left of tail pointer 506. Once the entry corresponding to the 0 bit value that tail pointer 506 is pointing to is flipped to a 1 bit value, tail pointer 506 may advance over the continuous run of 1 bit values and move 4 bits to the left.

Tail pointer 506 may then wait at the next 0 bit value until it is flipped. When it is flipped, tail pointer 506 may advance over the next continuous run of 1 bit values. In some cases, tail pointer 506 may advance just 1 bit at a time.

Unlike the “maximum+index” data structure, the “bit array” data structure can provide individual-entry granularity to its tail pointer updates.

On the consumer side, the tail pointer may wait at 1 bit values and once the value flips to a 0 bit value, the tail pointer may advance over any continuous run of 0 bit values.

As discussed before, multiple nodes can coordinate data structure updates if they finish processing an entry at (nearly) the same time.

FIG. 5B is a block diagram of a bit array data structure 508 for tracking the state of queue entries, according to at least one embodiment. In some embodiments, bit array 508 may be divided into one or more sections, such as section 510a, section 510b, and section 510c. Each section may include a tail bit indicator (e.g., tail indicator bit 512) and one or more queue entry bits (e.g., queue entry bits 514). Tail indicator bit 512 can indicate whether a tail pointer exists within section 510a of bit array 508. For example, on the producer side, if tail indicator bit 512 has a 1 bit value, the producer-side tail pointer may be in queue entry bits 514 of section 510a. On the consumer side, if tail indicator bit 512 has a 0 bit value, the consumer-side tail pointer may be queue entry bits 514 of section 510a. The tail pointer's specific location may be determined based on the values in queue entry bits 514.

For example, starting from the right side of queue entry bits 514, the tail pointer may be positioned right before the least-significant bit that indicates a record is “ready.” On the producer side, this could mean that the tail pointer is at the 0 bit value right before the first 1 bit value when evaluating queue entry bits 514 from right to left. On the consumer side, the tail pointer may be at the 1 bit value right before the first 0 bit value when evaluating queue entry bits 514 from right to left.

Because bit array 508 includes tail indicator bits and queue entry bits, there may be more bits in bit array 508 than there are entries in the corresponding queue. In some embodiments, bit array 508 may include one or more extra sections beyond those needed to represent the entries in the corresponding queue, as will be seen in FIG. 6. One or more formulas can be used to calculate the bit array index that corresponds to a particular queue index, and vice versa. In some embodiments, the calculations can be optimized by using integer operations instead of floating point operations.

Updates to bit array 508 can be performed in an efficient, lock-free manner due to the distributed tail indicator bits. Because the tail indicator bits are stored adjacent to the queue entry bits, as opposed to in another region of memory, no locks need to be acquired when modifying a section of the bit array in memory. For example, bit array 508 may be loaded from memory. Then, queue entry bits and/or the tail indicator bit of a particular section can be modified in a single instruction, increasing an efficiency of the memory operations and reducing the amount of time waiting for locks to be acquired and/or released. If a tail indicator bit of another section needs to be modified (e.g., to propagate the tail indicator bit from a first section to a second section), a second instruction can be executed.

FIG. 6 is a block diagram of a bit array data structure 602 for tracking the state of queue entries, according to at least one embodiment. Bit array 602 can include a plurality of sections, such as first section 604, second section 606, and remaining sections 608. Each section can have a tail bit indicator and a plurality of queue entry bits, as shown previously in FIG. 5B. In some embodiments, bit array 602 can include one or more extra sections beyond those needed to represent the entries in the corresponding queue. For example, the queue corresponding to bit array 602 may have entries that can be adequately represented with the queue entry bits in remaining sections 608. Bit array 602 can include first section 604 and second section 606 to ensure that producer-side head and tail pointer 610 and consumer-side head and tail pointer 612 are not attempting to flip bits in the same section at the same time. As shown in FIG. 6, bit array 602 can be initialized such that producer-side head and tail pointer 610 is one section size ahead of consumer-side head and tail pointer 612. The initial state for producer-side head and tail pointer 610 can be all zeros in the queue entry bits and a 1 in the tail bit indicator. The initial state for consumer-side head and tail pointer 612 can be all ones in the queue entry bits and a 0 in the tail bit indicator.

FIG. 7A is a block diagram of a segmented bit queue data structure 736 for tracking the state of queue entries, according to at least one embodiment. Queue 702 can include a plurality of entries, as discussed previously, and can include head pointer 716 and tail pointer 718. In some embodiments, queue 702 may be associated with multiple data structures. For example, a producer side of queue 702 may be associated with a first data structure and a first set of head and tail pointers, and a consumer side of queue 702 may be associated with a second data structure and a second set of head and tail pointers.

During the discussion of FIG. 7A, head pointer 716 and tail pointer 718 may be discussed in terms of “consumer-side” head and tail pointers, but it should be understood that the producer side of queue 702 operates similarly.

Queue 702 can be logically divided into a plurality of segments: segment 720, segment 722, segment 724, and segment 726. Each segment can be associated with a counter of the data structure associated with queue 702 (e.g., segmented bit queue 736). For example, segment 720 can be associated with counter 728, segment 722 can be associated with counter 730, segment 724 can be associated with counter 732, and segment 726 can be associated with counter 734.

As in other embodiments, as entries of queue 702 are provided to consumer nodes, head pointer 716 may advance over the entries. As depicted in FIG. 7A, entries that are currently being consumed are considered “in-use.” For example, head pointer 716 may have advanced over all the entries between tail pointer 718 and head pointer 716. Some of those entries are still being consumed, such as those entries in in-use region 706 and in-use region 710. Some of those entries have already been consumed and are ready to be deallocated, such as those in free region 708 and free region 712. The entries behind tail pointer 718 (e.g., entries in deallocated region 714) may have been previously consumed and already deallocated. The entries ahead of head pointer 716 (e.g., entries in ready region 704) may be “ready entries” that have already been produced and are ready to be consumed by one or more consumer nodes.

Once a particular entry has been consumed, the processor executing the consumer node can provide a signal that causes segmented bit queue 736 to be modified. Specifically, the signal can cause that a counter of segmented bit queue 736 associated with the segment of the consumed entry within queue 702 is incremented. Once a particular counter equals a predetermined threshold value, tail pointer 718 can be advanced over the segment of queue 702 corresponding to the counter.

For example, presuming there is one entry being consumed in in-use region 710, after the consumer node is finished accessing the data in in-use region 710, the processor executing the consumer node can provide a signal to cause segmented bit queue 736 to be modified.

Specifically, since the entry in in-use region 710 is within segment 724, the counter associated with segment 724 (e.g., counter 732) can be incremented. Incrementing counter 732 may cause the value stored in counter 732 to equal the predetermined threshold value. As a result, tail pointer 718 can advance over segment 724 and can now point at the far left side of segment 724, within free region 708. The queue entries in segment 724 may be subsequently deallocated.

Once the “consuming entries” within in-use region 706 that are part of segment 722 are done being consumed, counter 730 may be incremented to equal its predetermined threshold value, and tail pointer 718 may be able to advance over segment 722.

In some embodiments, a counter may be able to have a value greater than the number of queue entries in the corresponding queue segment. Thus, the predetermined threshold value for a particular counter may be equal to the number of queue entries within the segment corresponding to the counter to prevent the counter from getting too high. When the value of the counter equals the predetermined threshold value, one or more “guard bits” within the counter may be flipped.

In some embodiments, to prevent head pointer 716 from wrapping around queue 702 to point to the same segment as tail pointer 718, an initial gap can be introduced between head pointer 716 and tail pointer 718 to ensure head pointer 716 stays at least one segment length behind tail pointer 718.

In some embodiments, updates to segmented bit queue 738 for multiple consumer nodes can be combined into a single update.

In some embodiments, updates to segmented bit queue 738 may require more than one atomic memory operation (e.g., in order to clear one section's counters and update the tail indicator bit in another section).

In some embodiments, updates to segmented bit queue 738 can be performed using a single, dedicated atomic memory operation. The dedicated atomic memory operation may receive as input one or more values to increment one or more segment counters (e.g., counter 728, counter 730, etc.) and a bit indicating whether or not the tail indicator bit needs to be propagated to the next section. The dedicated atomic memory operation can return a value indicating whether or not the tail bit of the modified section needs to be propagated to the next section and a value indicating how much the tail pointer advanced as a result of the dedicated atomic memory operation.

For example, a section (e.g., section 740a) of segmented bit queue 738 may include 64-bits of data, such as 1 bit for the tail indicator, 15 bits for the local tail position bits, and 4 12-bit counters. Updating the values within the section may be performed using a single 64-bit atomic memory operation. If the dedicated atomic memory operation indicates that the tail bit needs to be propagated to the next section, a second dedicated atomic memory operation may be performed for the next section.

Similar to the bit array implementation discussed above, updates to segmented bit queue 738 can be performed in an efficient, lock-free manner due to the distributed tail indicator bits. Because the tail indicator bits are stored adjacent to the local tail position bits and the counter bits, as opposed to in another region of memory, no locks need to be acquired when modifying a particular section of the segmented bit queue. For example, segmented bit queue 738 may be loaded from memory. Then, counter bits, local tail position bits, and/or the tail indicator bit of a particular section can be modified in a single instruction, increasing an efficiency of the memory operations and reducing the amount of time waiting for locks to be acquired and/or released. If a tail indicator bit of another section needs to be modified (e.g., to propagate the tail indicator bit from a first section to a second section), a second instruction can be executed.

In some embodiments, a “wide” atomic memory operation can be used. For example, a wide atomic memory operation may be able to modify 128 or 256 bits of memory atomically. In such a case, a section of segmented bit queue 738 may be configured to match the size of the wide atomic. For example, if the wide atomic can modify 256 bits of memory in a single operation, a section of segmented bit queue 738 may include 256 bits of data, such as 1 bit for the tail indicator, 16 bits for the local tail position, 47 unused bits, and 16 12-bit counters.

FIG. 7B is a block diagram of a segmented bit queue data structure 738 for tracking the state of queue entries, according to at least one embodiment. In some embodiments, segmented bit queue 738 may be divided into one or more sections, such as section 740a, section 740b, and section 740c. Each section may include a tail bit indicator (e.g., tail indicator bit 742), one or more local tail position bits (e.g., local tail position 744), and one or more counters (e.g., counter 746, counter 748, counter 750, counter 752, etc.). Tail indicator bit 742 can indicate whether a tail pointer exists within one of the segments of the queue corresponding to the counters of section 740a of segmented bit queue 738. For example, on the producer side, if tail indicator bit 742 has a 1 bit value, the producer-side tail pointer may be within a segment corresponding to counter 746, counter 748, counter 750, or counter 752. To identify exactly where the tail pointer is, local tail position 744 can include a value that represents an offset within the region of the queue corresponding to section 740a that identifies the position of the tail pointer.

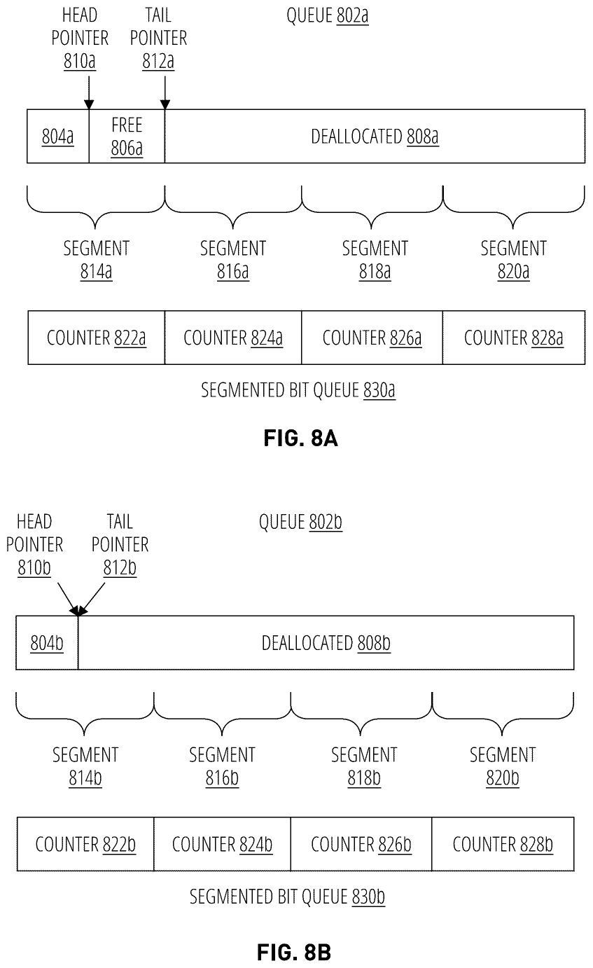

FIG. 8A is a block diagram of a segmented bit queue data structure 830a for tracking the state of queue entries that can be “partially deallocated,” according to at least one embodiment. Queue 802a can include a plurality of entries, as discussed previously, and can include head pointer 810a and tail pointer 812a. In some embodiments, queue 802a may be associated with multiple data structures. For example, a producer side of queue 802a may be associated with a first data structure and a first set of head and tail pointers, and a consumer side of queue 802a may be associated with a second data structure and a second set of head and tail pointers.

During discussion of FIG. 8A, head pointer 810a and tail pointer 812a may be discussed in terms of “consumer-side” head and tail pointers, but it should be understood that the producer side of queue 802a operates similarly.

Queue 802a can be logically divided into a plurality of segments: segment 814a, segment 816a, segment 818a, and segment 820a. Each segment can be associated with a counter of the data structure associated with queue 802a (e.g., segmented bit queue 830a). For example, segment 814a can be associated with counter 822a, segment 816a can be associated with counter 824a, segment 818a can be associated with counter 826a, and segment 820a can be associated with counter 828a.

As in other embodiments, as entries of queue 802a are provided to consumer nodes, head pointer 810a may advance over the entries. For example, all the entries between tail pointer 812a and head pointer 810a (e.g., entries in free region 806a) may have been provided to consumer nodes and may have already been consumed. As additional entries are provided to consumer nodes, head pointer 810a may advance into ready region 804a. Entries over which tail pointer 812a has already advanced (e.g., entries in deallocated region 808a) may have already been deallocated.

As depicted in FIG. 8A, entries in free region 806a may be ready to be deallocated. However, since all of segment 814a isn't ready to be deallocated, tail pointer 812a may not be able to advance over the free entries and deallocate them. This can lead to deadlock.

To prevent deadlocks, in some embodiments, if head pointer 810a and tail pointer 812a are in (e.g., point to) the same segment of the queue (e.g., segment 814a), tail pointer 812a can be partially advanced through the segment. For example, if a partial advance criterion is satisfied, tail pointer 812a can be safely advanced to the same position as head pointer 810a. In such a case, tail pointer 812a can track the individual entries (e.g., index values of the corresponding entries) that have been passed over. In some embodiments, the partial advance criterion is satisfied when the number of entries between head pointer 810a and the start of the current segment (e.g., segment 814a) is equal to the value of the corresponding counter (e.g., counter 822a). In some embodiments, the partial advance criterion is satisfied when the sum of the counters for segments within a section that are at or before the head pointer's position equal the difference between the head pointer's position and the beginning of the section. Thus, the partial advance criterion can be based on a segment granularity, on a section granularity, and/or the like.

Thus, when the head pointer and the tail pointer are within the same segment, entries within the segment can be deallocated without waiting for the entire segment to be provided to consumer nodes and marked ready to be deallocated.

FIG. 8B is a block diagram of a “partially deallocated” segmented bit queue data structure 830b for tracking the state of queue entries, according to at least one embodiment. Queue 802b can be logically divided into a plurality of segments which each correspond to a counter of segmented bit queue 830b. For example, segment 814b may correspond to counter 822b, segment 816b may correspond to counter 824b, segment 818b may correspond to counter 826b, and segment 820b may correspond to counter 828b.

Queue 802b can correspond to queue 802a after queue 802a has been partially deallocated, as discussed in relation to FIG. 8A. Deallocated region 808b of queue 802b may now be expanded to cover part of segment 814b, and head pointer 810b and tail pointer 812b may point to the same entry in queue 802b. As additional entries are provided to consumer nodes, head pointer 810b may advance into ready region 804b.

In some cases, segment 814b can be partially deallocated again. For example, if head pointer 810b advances over two entries and those two entries are consumed and are ready to be deallocated, counter 822b may be equal to the number of entries between head pointer 810b and the start of segment 814b. Tail pointer 812b may advance over the same two entries and may point at the same entry as head pointer 810b. The two entries can then be deallocated.

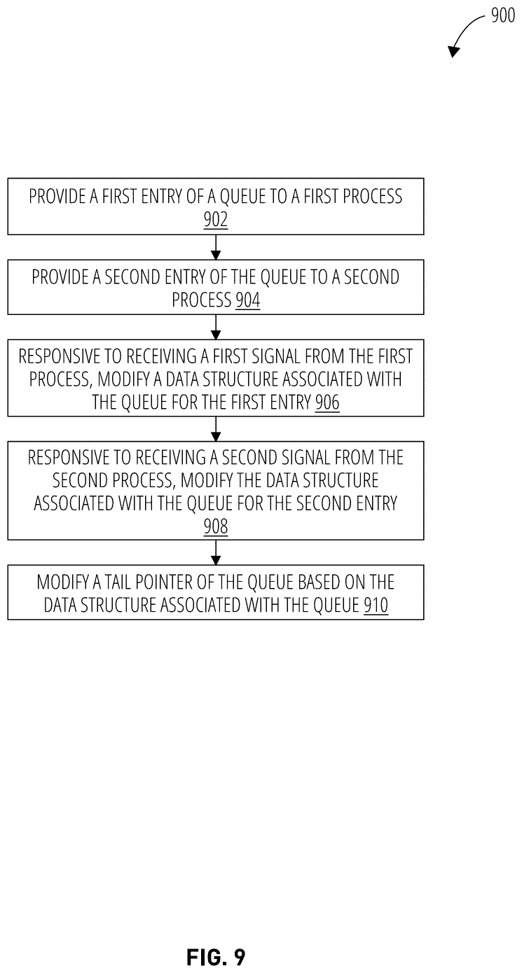

FIG. 9 is a flow diagram of an example method 900 for tracking the state of entries in a queue, according to at least one embodiment.

Method 900 can be performed using one or more processing units (e.g., CPUs, GPUs, accelerators, physics processing units (PPUs), data processing units (DPUs), etc.), which may include (or communicate with) one or more memory devices. In at least one embodiment, method 900 can be performed using a processing device or processing devices. In at least one embodiment, method 900 can be performed using processing circuitry of system 102 of FIG. 1. In at least one embodiment, processing units performing method 900 can be executing instructions stored on a non-transient computer readable storage media. In at least one embodiment, method 900 can be performed using multiple processing threads (e.g., CPU threads and/or GPU threads), individual threads executing one or more individual functions, routines, subroutines, or operations of the method. In at least one embodiment, processing threads implementing method 900 can be synchronized (e.g., using semaphores, critical sections, and/or other thread synchronization mechanisms). Alternatively, processing threads implementing method 900 can be executed asynchronously with respect to each other. Various operations of method 900 can be performed in a different order compared with the order shown in FIG. 9. Some operations of method 900 can be performed concurrently with other operations. In at least one embodiment, one or more operations shown in FIG. 9 may not always be performed.

FIG. 9 is a flow diagram of an example method 900 for tracking the state of entries in a queue, according to at least one embodiment. At block 902, processing units executing method 900 can provide a first entry of a queue to a first process. At block 904, processing units can provide a second entry of the queue to a second process. At block 906, processing units can, responsive to receiving a first signal from the first process, modify a data structure associated with the queue for the first entry. At block 908, processing units can, responsive to receiving a second signal from the second process, modify the data structure associated with the queue for the second entry. At block 910, processing units can modify a tail pointer of the queue based on the data structure associated with the queue.

In some embodiments, additional queue entries can be provided to additional processes. As a signal is received from each process, the data structure associated with the queue can be modified for the queue entry provided to the process. Thus, queue entries can be provided to two or more processes, and a data structure associated with the queue can be modified for each queue entry responsive to receiving a signal from the process that received the queue entry.

In some embodiments, the data structure associated with the queue includes a maximum index and a current index. Modifying the data structure associated with the queue for the first entry can include modifying the maximum index based on a first index of the first entry within the queue and incrementing the current index of the data structure. Modifying the data structure associated with the queue for the second entry can include modifying the maximum index based on a second index of the second entry within the queue and incrementing the current index of the data structure. Modifying the tail pointer of the queue based on the data structure associated with the queue can include, responsive to the maximum index equaling the current index, modifying the tail pointer of the queue to equal the maximum index.

In some embodiments, the first process is a producer process that stores one or more data values in the first entry of the queue. The first signal from the first process may indicate that the first entry of the queue is ready to be consumed by a consumer process. In some embodiments, the first process is a consumer process that performs one or more operations based on data values in the first entry of the queue. The first signal from the first process may indicate that the first entry of the queue is ready to be deallocated.

In some embodiments, the data structure associated with the queue includes a bit array with one or more bits corresponding to indices in the queue. The bit array may also include one or more sections, where each section includes a tail indicator bit and a plurality of queue entry bits. The one or more bits corresponding to the indices in the queue may be included in the plurality of queue entry bits. In some embodiments, a first subset of the one or more bits corresponding to the indices in the queue may be included in the plurality of queue entry bits of a first section, and a second subset of the one or more bits corresponding to the indices in the queue may be included in the plurality of queue entry bits of a second section. Modifying the data structure associated with the queue for the first entry can include modifying a first bit of the bit array corresponding to a first queue index of the first entry. Modifying the data structure associated with the queue for the second entry can include modifying a second bit of the bit array corresponding to a second queue index of the second entry. Modifying the tail pointer of the queue based on the data structure associated with the queue can include modifying the tail pointer of the queue based on a consecutive run of values of the bit array. For example, if the bit array entry corresponding to queue entry the tail pointer is pointing to is flipped (e.g., from 0 to 1 or from 1 to 0), the tail pointer may advance over adjacent entries (e.g., a continuous run of entries) that have corresponding bit array entries with values equal to the flipped value. For example, if the bit array entry flips from 0 to 1 and there are 3 more 1 bit values to the left (e.g., toward the head pointer), the tail pointer may advance over 3 entries in the queue and point at the next queue entry, which may have a corresponding bit array value of 0.

In some embodiments, the queue includes a plurality of segments. The data structure associated with the queue may include a plurality of sections, where each section includes one or more counters each associated with a segment of the plurality of segments. In some embodiments, a first section of the plurality of sections includes a tail indicator bit, one or more tail address bits (e.g., local tail position bits), the first counter, and the second counter.

Modifying the data structure associated with the queue for the first entry can include incrementing a first counter. The first entry may be in a first segment of the plurality of segments of the queue, and the first counter may be associated with the first segment of the plurality of segments. Modifying the data structure associated with the queue for the second entry can include incrementing a second counter. The second entry may be in a second segment of the plurality of segments of the queue, and the second counter may be associated with the second segment of the plurality of segments. Modifying the tail pointer of the queue based on the data structure associated with the queue can include, responsive to a particular counter satisfying a threshold criterion, modifying the tail pointer of the queue to equal an end of a particular segment associated with the particular counter. For example, the tail pointer of the queue may point to an entry at the end of the particular segment associated with the particular counter (e.g., the last entry of the particular segment) or may point to the first entry in a segment next to the particular segment.

In some embodiments, the first counter and the second counter each have one or more guard bits to indicate whether the threshold criterion associated with the counter has been satisfied. For example, if a particular counter has reached the threshold criterion, the guard bits of the counter may all be flipped to 1 (or 0).

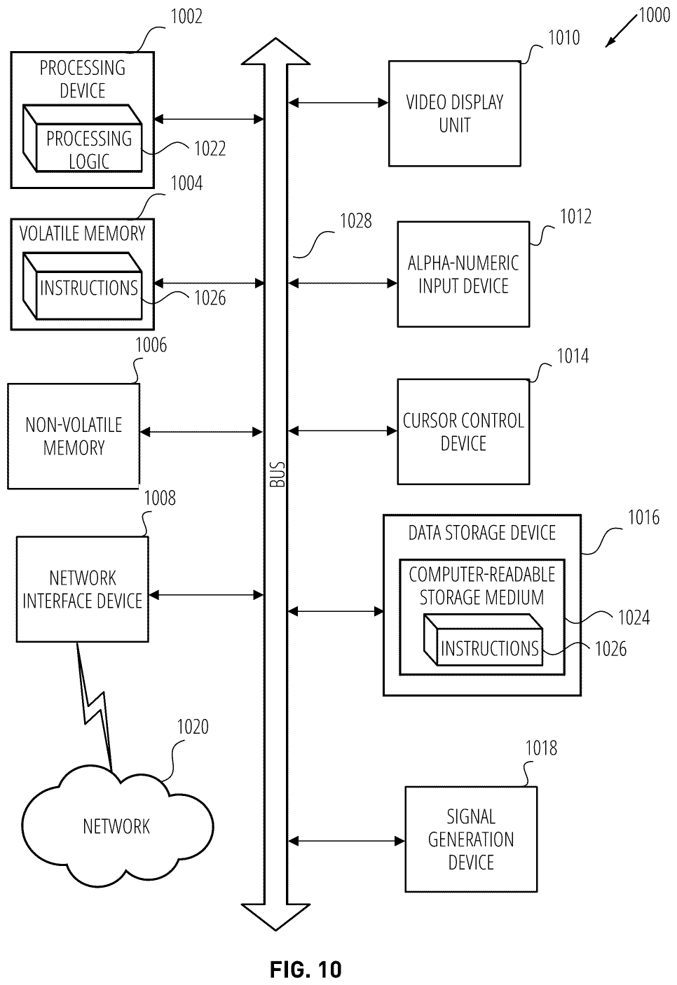

FIG. 10 is a block diagram illustrating an exemplary computer system, in accordance with at least one embodiment of the present disclosure. The computer system 1000 can correspond to system 102, described with respect to FIG. 1. Computer system 1000 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a main memory 1004 (e.g., read-only memory (ROM), flash memory, dynamic random access memory (DRAM) such as synchronous DRAM (SDRAM), double data rate (DDR SDRAM), or DRAM (RDRAM), etc.), a static memory 1006 (e.g., flash memory, static random access memory (SRAM), etc.), and a data storage device 1016, which communicate with each other via a bus 1028.

Processor (processing device) 1002 represents one or more general-purpose processing devices such as a microprocessor, central processing unit, or the like, and may include processing logic 1022. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute instructions 1026 (e.g., for generating threat indicator alerts) for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1018 (e.g., a speaker). In some embodiments, computer system 1000 may not include video display unit 1010, input device 1012, and/or cursor control device 1014 (e.g., in a headless configuration).

The data storage device 1016 can include a non-transitory machine-readable storage medium 1024 (also computer-readable storage medium) on which is stored one or more sets of instructions 1026 (e.g., for tracking the state of entries in a queue) embodying any one or more of the methodologies or functions described herein. The instructions 1026 can also reside, completely or at least partially, within the main memory 1004 and/or within the processor 1002 during execution thereof by the computer system 1000, the main memory 1004 and the processor 1002 also constituting machine-readable storage media. The instructions can further be transmitted or received over a network 1020 via the network interface device 1008.

In one implementation, the instructions 1026 include instructions for tracking the state of entries in a queue. While the computer-readable storage medium 1024 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

### Inference and Training Logic

FIG. 11A illustrates inference and/or training logic 1115 used to perform inferencing and/or training operations associated with one or more embodiments.

In at least one embodiment, inference and/or training logic 1115 may include, without limitation, code and/or data storage 1101 to store forward and/or output weight and/or input/output data, and/or other parameters to configure neurons or layers of a neural network trained and/or used for inferencing in aspects of one or more embodiments. In at least one embodiment, training logic 1115 may include (or be coupled to code and/or data storage 1101 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 1101 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 1101 may be included with other on-chip or off-chip data storage, including a processor's L1, L2, or L3 cache or system memory.

In at least one embodiment, any portion of code and/or data storage 1101 may be internal or external to one or more processors or other hardware logic devices or circuits. In at least one embodiment, code and/or data storage 1101 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 1101 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1115 may include, without limitation, a code and/or data storage 1105 to store backward and/or output weight and/or input/output data corresponding to neurons or layers of a neural network trained and/or used for inferencing in aspects of one or more embodiments. In at least one embodiment, code and/or data storage 1105 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 1115 may include (or be coupled to code and/or data storage 1105 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 1105 may be included with other on-chip or off-chip data storage, including a processor's L1, L2, or L3 cache or system memory. In at least one embodiment, any portion of code and/or data storage 1105 may be internal or external to one or more processors or other hardware logic devices or circuits. In at least one embodiment, code and/or data storage 1105 may be cache memory, DRAM, SRAM, non-volatile memory (e.g., flash memory), or other storage. In at least one embodiment, a choice of whether code and/or data storage 1105 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 1101 and code and/or data storage 1105 may be separate storage structures. In at least one embodiment, code and/or data storage 1101 and code and/or data storage 1105 may be a combined storage structure. In at least one embodiment, code and/or data storage 1101 and code and/or data storage 1105 may be partially combined and partially separate. In at least one embodiment, any portion of code and/or data storage 1101 and code and/or data storage 1105 may be included with other on-chip or off-chip data storage, including a processor's L1, L2, or L3 cache or system memory.

In at least one embodiment, inference and/or training logic 1115 may include, without limitation, one or more arithmetic logic unit(s) (“ALU(s)”) 1110, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1120 that are functions of input/output and/or weight parameter data stored in code and/or data storage 1101 and/or code and/or data storage 1105. In at least one embodiment, activations stored in activation storage 1120 are generated according to linear algebraic and/or matrix-based mathematics performed by ALU(s) 1110 in response to performing instructions or other code, wherein weight values stored in code and/or data storage 1105 and/or code and/or data storage 1101 are used as operands along with other values, such as bias values, gradient information, momentum values, or other parameters or hyperparameters, any or all of which may be stored in code and/or data storage 1105 or code and/or code and/or data storage 1101 or another storage on or off-chip.

In at least one embodiment, ALU(s) 1110 are included within one or more processors or other hardware logic devices or circuits, whereas in another embodiment, ALU(s) 1110 may be external to a processor or other hardware logic device or circuit that uses them (e.g., a co-processor). In at least one embodiment, ALU(s) 1110 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 1101, code and/or data storage 1105, and activation storage 1120 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 1120 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 1120 may be cache memory, DRAM, SRAM, non-volatile memory (e.g., flash memory), or other storage. In at least one embodiment, activation storage 1120 may be completely or partially within or external to one or more processors or other logical circuits. In at least one embodiment, a choice of whether activation storage 1120 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1115 illustrated in FIG. 11A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 1115 illustrated in FIG. 11A may be used in conjunction with central processing unit (“CPU”) hardware, graphics processing unit (“GPU”) hardware or other hardware, such as field programmable gate arrays (“FPGAs”).

FIG. 11B illustrates inference and/or training logic 1115, according to at least one embodiment. In at least one embodiment, inference and/or training logic 1115 may include, without limitation, hardware logic in which computational resources are dedicated or otherwise exclusively used in conjunction with weight values or other information corresponding to one or more layers of neurons within a neural network. In at least one embodiment, inference and/or training logic 1115 illustrated in FIG. 11B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 1115 illustrated in FIG. 11B may be used in conjunction with central processing unit (CPU) hardware, graphics processing unit (GPU) hardware or other hardware, such as field programmable gate arrays (FPGAs). In at least one embodiment, inference and/or training logic 1115 includes, without limitation, code and/or data storage 1101 and code and/or data storage 1105, which may be used to store code (e.g., graph code), weight values and/or other information, including bias values, gradient information, momentum values, and/or other parameter or hyperparameter information. In at least one embodiment illustrated in FIG. 11B, each of code and/or data storage 1101 and code and/or data storage 1105 is associated with a dedicated computational resource, such as computational hardware 1102 and computational hardware 1106, respectively. In at least one embodiment, each of computational hardware 1102 and computational hardware 1106 comprises one or more ALUs that perform mathematical functions, such as linear algebraic functions, only on information stored in code and/or data storage 1101 and code and/or data storage 1105, respectively, the result of which is stored in activation storage 1120.

In at least one embodiment, each of code and/or data storage 1101 and 1105 and corresponding computational hardware 1102 and 1106, respectively, correspond to different layers of a neural network, such that resulting activation from one storage/computational pair 1101/1102 of code and/or data storage 1101 and computational hardware 1102 is provided as an input to a next storage/computational pair 1105/1106 of code and/or data storage 1105 and computational hardware 1106, in order to mirror a conceptual organization of a neural network. In at least one embodiment, each of storage/computational pairs 1101/1102 and 1105/1106 may correspond to more than one neural network layer. In at least one embodiment, additional storage/computation pairs (not shown) subsequent to or in parallel with storage/computation pairs 1101/1102 and 1105/1106 may be included in inference and/or training logic 1115.

### Neural Network Training and Deployment

FIG. 12 illustrates training and deployment of a deep neural network, according to at least one embodiment. In at least one embodiment, untrained neural network 1206 is trained using a training dataset 1202. In at least one embodiment, training framework 1204 is a PyTorch framework, whereas in other embodiments, training framework 1204 is a TensorFlow, Boost, Caffe, Microsoft Cognitive Toolkit/CNTK, MXNet, Chainer, Keras, Deeplearning4j, or other training framework. In at least one embodiment, training framework 1204 trains an untrained neural network 1206 and enables it to be trained using processing resources described herein to generate a trained neural network 1208. In at least one embodiment, weights may be chosen randomly or by pre-training using a deep belief network. In at least one embodiment, training may be performed in either a supervised, partially supervised, or unsupervised manner.

In at least one embodiment, untrained neural network 1206 is trained using supervised learning, wherein training dataset 1202 includes an input paired with a desired output for an input, or where training dataset 1202 includes input having a known output and an output of neural network 1206 is manually graded. In at least one embodiment, untrained neural network 1206 is trained in a supervised manner and processes inputs from training dataset 1202 and compares resulting outputs against a set of expected or desired outputs. In at least one embodiment, errors are then propagated back through untrained neural network 1206. In at least one embodiment, training framework 1204 adjusts weights that control untrained neural network 1206. In at least one embodiment, training framework 1204 includes tools to monitor how well untrained neural network 1206 is converging towards a model, such as trained neural network 1208, suitable to generating correct answers, such as in result 1214, based on input data such as a new dataset 1212. In at least one embodiment, training framework 1204 trains untrained neural network 1206 repeatedly while adjusting weights to refine an output of untrained neural network 1206 using a loss function and adjustment algorithm, such as stochastic gradient descent. In at least one embodiment, training framework 1204 trains untrained neural network 1206 until untrained neural network 1206 achieves a desired accuracy. In at least one embodiment, trained neural network 1208 can then be deployed to implement any number of machine learning operations.

In at least one embodiment, untrained neural network 1206 is trained using unsupervised learning, wherein untrained neural network 1206 attempts to train itself using unlabeled data. In at least one embodiment, unsupervised learning training dataset 1202 will include input data without any associated output data or “ground truth” data. In at least one embodiment, untrained neural network 1206 can learn groupings within training dataset 1202 and can determine how individual inputs are related to untrained dataset 1202. In at least one embodiment, unsupervised training can be used to generate a self-organizing map in trained neural network 1208 capable of performing operations useful in reducing dimensionality of new dataset 1212. In at least one embodiment, unsupervised training can also be used to perform anomaly detection, which allows identification of data points in new dataset 1212 that deviate from normal patterns of new dataset 1212.

In at least one embodiment, semi-supervised learning may be used, which is a technique in which training dataset 1202 includes a mix of labeled and unlabeled data. In at least one embodiment, training framework 1204 may be used to perform incremental learning, such as through transferred learning techniques. In at least one embodiment, incremental learning enables trained neural network 1208 to adapt to new dataset 1212 without forgetting knowledge instilled within trained neural network 1208 during initial training.

With reference to FIG. 13, FIG. 13 is an example data flow diagram for a process 1300 of generating and deploying a processing and inferencing pipeline, according to at least one embodiment. In at least one embodiment, process 1300 may be deployed to perform game name recognition analysis and inferencing on user feedback data at one or more facilities 1302, such as a data center.

In at least one embodiment, process 1300 may be executed within a training system 1304 and/or a deployment system 1306. In at least one embodiment, training system 1304 may be used to perform training, deployment, and embodiment of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, deployment system 1306 may provide a streamlined platform for selecting, customizing, and implementing virtual instruments for use with computing devices at facility 1302. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 1306 during execution of applications.

In at least one embodiment, some applications used in advanced processing and inferencing pipelines may use machine learning models or other AI to perform one or more processing steps. In at least one embodiment, machine learning models may be trained at facility 1302 using feedback data 1308 (such as imaging data) stored at facility 1302 or feedback data 1308 from another facility or facilities, or a combination thereof. In at least one embodiment, training system 1304 may be used to provide applications, services, and/or other resources for generating working, deployable machine learning models for deployment system 1306.

In at least one embodiment, a model registry 1324 may be backed by object storage that may support versioning and object metadata. In at least one embodiment, object storage may be accessible through, for example, a cloud storage (e.g., a cloud 1426 of FIG. 14) compatible application programming interface (API) from within a cloud platform. In at least one embodiment, machine learning models within model registry 1324 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 1404 (FIG. 14) may include a scenario where facility 1302 is training their own machine learning model or has an existing machine learning model that needs to be optimized or updated. In at least one embodiment, feedback data 1308 may be received from various channels, such as forums, web forms, or the like. In at least one embodiment, once feedback data 1308 is received, AI-assisted annotation 1310 may be used to aid in generating annotations corresponding to feedback data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of feedback data 1308 (e.g., from certain devices) and/or certain types of anomalies in feedback data 1308. In at least one embodiment, AI-assisted annotations 1310 may then be used directly, or may be adjusted or fine-tuned using an annotation tool, to generate ground truth data. In at least one embodiment, in some examples, labeled data 1312 may be used as ground truth data for training a machine learning model. In at least one embodiment, AI-assisted annotations 1310, labeled data 1312, or a combination thereof may be used as ground truth data for training a machine learning model, e.g., via model training 1314 in FIG. 13 and/or FIG. 14. In at least one embodiment, a trained machine learning model may be referred to as an output model 1316, and may be used by deployment system 1306, as described herein.

In at least one embodiment, training pipeline(s) 1404 (FIG. 14) may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities that are remotely located). In at least one embodiment, machine learning models may have been trained on imaging data from one location, two locations, or any number of locations. In at least one embodiment, when being trained on imaging data, which may be a form of feedback data 1308, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, training pipeline(s) 1404 (FIG. 14) may be used in a scenario that includes facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 might not be fine-tuned or optimized for feedback data 1308 generated at facility 1302 because of differences in populations, genetic variations, robustness of training data used to train a machine learning model, diversity in anomalies of training data, and/or other issues with training data. In at least one embodiment, AI-assisted annotation 1310 may be used to aid in generating annotations corresponding to feedback data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314 may include data - e.g., AI-assisted annotations 1310, labeled data 1312, or a combination thereof - that may be used as ground truth data for retraining or updating a machine learning model.

In at least one embodiment, deployment system 1306 may include software 1318, service 1320, hardware 1322, and/or other components, features, and functionality. In at least one embodiment, deployment system 1306 may include a software “stack,” such that software 1318 may be built on top of service 1320 and may use service 1320 to perform some or all of processing tasks, and service 1320 and software 1318 may be built on top of hardware 1322 and use hardware 1322 to execute processing, storage, and/or other compute tasks of deployment system 1306.

In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 1308 (or other data types, such as those described herein). In at least one embodiment, an advanced processing and inferencing pipeline may be defined based on selections of different containers that are desired or required for processing feedback data 1308, in addition to containers that receive and configure imaging data for use by each container and/or for use by facility 1302 after processing through a pipeline (e.g., to convert outputs back to a usable data type for storage and display at facility 1302). In at least one embodiment, a combination of containers within software 1318 (e.g., that make up a pipeline) may be referred to as a virtual instrument (as described in more detail herein), and a virtual instrument may leverage service 1320 and hardware 1322 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 14). In at least one embodiment, once validated by system 1400 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1400 of FIG. 14). In at least one embodiment, completed and validated applications or containers may be stored in a container registry and associated machine learning models may be stored in model registry 1324. In at least one embodiment, a requesting entity that provides an inference or image processing request may browse a container registry and/or model registry 1324 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 1306 (e.g., a cloud) to perform processing of a data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 1320 may be leveraged. In at least one embodiment, service 1320 may include compute services, collaborative content creation services, simulation services, artificial intelligence (AI) services, visualization services, and/or other service types. In at least one embodiment, service 1320 may provide functionality that is common to one or more applications in software 1318, so functionality may be abstracted to a service that may be called upon or leveraged by applications. In at least one embodiment, functionality provided by service 1320 may run dynamically and more efficiently, while also scaling well by allowing applications to process data in parallel, e.g., using a parallel computing platform 1430 (FIG. 14). In at least one embodiment, rather than each application that shares a same functionality offered by a service 1320 being required to have a respective instance of service 1320, service 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 1320 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 1318 implementing advanced processing and inferencing pipeline may be streamlined because each application may call upon the same inference service to perform one or more inferencing tasks.

In at least one embodiment, hardware 1322 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 1322 may be used to provide efficient, purpose-built support for software 1318 and service 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of game name recognition.

In at least one embodiment, software 1318 and/or service 1320 may be optimized for GPU processing with respect to deep learning, machine learning, and/or high-performance computing, simulation, and visual computing, as non-limiting examples. In at least one embodiment, at least some of the computing environment of deployment system 1306 and/or training system 1304 may be executed in a datacenter or one or more supercomputers or high performance computing systems, with GPU-optimized software (e.g., hardware and software combination of NVIDIA's DGX™ system). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying a deployment pipeline, according to at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public internet service providers (ISPs) that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipeline(s) 1404 may be used to train or retrain one or more (e.g., pre-trained) models, and/or implement one or more of pre-trained models 1406 (e.g., without a need for retraining or updating). In at least one embodiment, as a result of training pipeline(s) 1404, output model(s) 1316 may be generated. In at least one embodiment, training pipeline(s) 1404 may include any number of processing steps, AI-assisted annotation 1310, labeling or annotating of feedback data 1308 to generate labeled data 1312, model selection from a model registry, model training 1314, training, retraining, or updating models, and/or other processing steps. In at least one embodiment, DICOM adapter 1402a can be used to access DICOM data. In at least one embodiment, for different machine learning models used by deployment system 1306, different training pipeline(s) 1404 may be used. In at least one embodiment, training pipeline(s) 1404, similar to a first example described with respect to FIG. 13, may be used for a first machine learning model, training pipeline(s) 1404, similar to a second example described with respect to FIG. 13, may be used for a second machine learning model, and training pipeline(s) 1404, similar to a third example described with respect to FIG. 13, may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304 and may be implemented by deployment system 1306.

In at least one embodiment, output model(s) 1316 and/or pre-trained models 1406 may include any types of machine learning models depending on embodiment. In at least one embodiment, and without limitation, machine learning models used by system 1400 may include machine learning model(s) using linear regression, logistic regression, decision trees, support vector machines (SVM), Naëve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 1404 may include AI-assisted annotation. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of, AI-assisted annotation included in training pipeline(s) 1404. In at least one embodiment, system 1400 may include a multi-layer platform that may include a software layer (e.g., software 1318) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 1302. In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner.

In at least one embodiment, deployment system 1306 may execute deployment pipelines 1410. In at least one embodiment, deployment pipeline(s) 1410 may include any number of applications that may be sequentially, non-sequentially, or otherwise applied to feedback data (and/or other data types), including AI-assisted annotation, as described above.

In at least one embodiment, as described herein, a deployment pipeline(s) 1410 for an individual device may be referred to as a virtual instrument for a device. In at least one embodiment, for a single device, there may be more than one deployment pipeline(s) 1410 depending on information desired from data generated by a device.

In at least one embodiment, applications available for deployment pipeline(s) 1410 may include any application that may be used for performing processing tasks on feedback data or other data from devices. In at least one embodiment, because various applications may share common image operations, in some embodiments, a data augmentation library (e.g., as one of services 1320) may be used to accelerate these operations. In at least one embodiment, to avoid bottlenecks of conventional processing approaches that rely on CPU processing, parallel computing platform 1430 may be used for GPU acceleration of these processing tasks.

In at least one embodiment, deployment system 1306 may include a user interface (UI) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to service 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of the applications or containers. In at least one embodiment, because one or more of applications or containers in deployment pipeline(s) 1410 may share the same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged and shared by applications or containers in deployment system 1306 may include compute service(s) 1416, collaborative content creation service(s) 1417, AI service(s) 1418, simulation service(s) 1419, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA®) may enable general purpose computing on GPUs (GPGPU) (e.g., GPUs/graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system(s) 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data (e.g., DICOM data, RIS data, CIS data, REST compliant data, RPC data, raw data, etc.). For example, DICOM adapter 1402b may be used to access DICOM data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/graphics 1422 may be leveraged by visualization service(s) 1420 to generate visualizations. In at least one embodiment, rendering effects, such as ray-tracing or other light transport simulation techniques, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/graphics 1422, AI system(s) 1424, cloud 1426, and/or any other hardware used for executing training system 1304 and/or deployment system 1306. In at least one embodiment, GPUs/graphics 1422 (e.g., NVIDIA's TESLA® and/or QUADRO® GPUs) may include any number of GPUs that may be used for executing processing tasks of compute service(s) 1416, collaborative content creation service(s) 1417, AI service(s) 1418, simulation service(s) 1419, visualization service(s) 1420, other services, and/or any of features or functionality of software 1318. For example, with respect to AI service(s) 1418, GPUs/graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system(s) 1424, and/or other components of system 1400 may use GPUs/graphics 1422. In at least one embodiment, cloud 1426 may include a GPU-optimized platform for deep learning tasks. In at least one embodiment, AI system(s) 1424 may use GPUs, and cloud 1426—or at least a portion tasked with deep learning or inferencing—may be executed using one or more AI system(s)s 1424. As such, although hardware 1322 is illustrated as discrete components, this is not intended to be limiting, and any components of hardware 1322 may be combined with, or leveraged by, any other components of hardware 1322.

In at least one embodiment, AI system(s) 1424 may include a purpose-built computing system (e.g., a super-computer or an HPC) configured for inferencing, deep learning, machine learning, and/or other artificial intelligence tasks. In at least one embodiment, AI system(s) 1424 (e.g., NVIDIA's DGX^{TM}) may include GPU-optimized software (e.g., a software stack) that may be executed using a plurality of GPUs/graphics 1422, in addition to CPUs, RAM, storage, and/or other components, features, or functionality. In at least one embodiment, one or more AI system(s)s 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC™) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may be tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TensorRT™), provide an accelerated parallel computing platform 1430 (e.g., NVIDIA's CUDA®), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400. In at least one embodiment, parallel computing platform 1430 may include an API.

In at least one embodiment, in an effort to preserve patient confidentiality (e.g., where patient data or records are to be used off-premises), cloud 1426 may include a registry, such as a deep learning container registry. In at least one embodiment, a registry may store containers for instantiations of applications that may perform pre-processing, post-processing, or other processing tasks on patient data. In at least one embodiment, cloud 1426 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
providing a first entry of a queue to a first process, wherein the queue comprises a plurality of segments;
providing a second entry of the queue to a second process;
responsive to receiving a first signal from the first process, modifying a data structure associated with the queue for the first entry, wherein the data structure associated with the queue comprises a plurality of sections, wherein each section comprises one or more counters each associated with a segment of the plurality of segments, and wherein modifying the data structure associated with the queue for the first entry comprises incrementing a first counter;
responsive to receiving a second signal from the second process, modifying the data structure associated with the queue for the second entry, wherein modifying the data structure comprises incrementing a second counter; and
modifying a tail pointer of the queue based on the data structure associated with the queue.

2. The method of claim 1, wherein:
the first entry is in a first segment of the plurality of segments;
the first counter is associated with the first segment of the plurality of segments;
the second entry is in a second segment of the plurality of segments; and
the second counter is associated with the second segment of the plurality of segments.

3. The method of claim 2, wherein modifying the tail pointer of the queue based on the data structure associated with the queue comprises, responsive to a particular counter satisfying a threshold criterion, modifying the tail pointer of the queue to equal an end of a particular segment associated with the particular counter.

4. The method of claim 3, further comprising determining that a head pointer of the queue and the tail pointer point to a same segment of the queue, wherein modifying the tail pointer of the queue based on the data structure associated with the queue comprises, responsive to a counter corresponding to the same segment of the queue satisfying a partial advance criterion, modifying the tail pointer of the queue to equal a position of the head pointer.

5. The method of claim 2, wherein a first section of the plurality of sections comprises a tail indicator bit, one or more tail address bits, the first counter, and the second counter.

6. The method of claim 3, wherein the first counter and the second counter each have a guard bit to indicate whether the threshold criterion has been satisfied.

7. The method of claim 1, wherein the first process is a producer process that stores one or more data values in the first entry of the queue.

8. A system comprising:
a memory storing a queue and a data structure associated with the queue, wherein the queue comprises a plurality of segments and the data structure associated with the queue comprises a plurality of sections, and wherein each section comprises one or more counters each associated with a segment of the plurality of segments; and
processing circuitry coupled to the memory, the processing circuitry to:
provide a first entry of the queue to a first process;
provide a second entry of the queue to a second process;
responsive to receiving a first signal from the first process, modify the data structure associated with the queue for the first entry, wherein to modify the data structure for the first entry the processing circuitry is to increment a first counter;
responsive to receiving a second signal from the second process, modify the data structure associated with the queue for the second entry, wherein to modify the data structure for the second entry the processing circuitry is to increment a second counter; and
modify a tail pointer of the queue based on the data structure associated with the queue.

9. The system of claim 8, wherein:
the first entry is in a first segment of the plurality of segments;
the first counter is associated with the first segment of the plurality of segments;
the second entry is in a second segment of the plurality of segments; and
the second counter is associated with the second segment of the plurality of segments.

10. The system of claim 9, wherein to modify the tail pointer of the queue based on the data structure associated with the queue, the processing circuitry is to, responsive to a particular counter satisfying a threshold criterion, modify the tail pointer of the queue to equal an end of a particular segment associated with the particular counter.

11. The system of claim 10, wherein the processing circuitry is further to determine that a head pointer of the queue and the tail pointer point to a same segment of the queue, wherein to modify the tail pointer of the queue based on the data structure associated with the queue, the processing circuitry is to, responsive to a counter corresponding to the same segment of the queue satisfying a partial advance criterion, modify the tail pointer of the queue to equal a position of the head pointer.

12. The system of claim 9, wherein a first section of the plurality of sections comprises a tail indicator bit, one or more tail address bits, the first counter, and the second counter.

13. The system of claim 10, wherein the first counter and the second counter each have a guard bit to indicate whether the threshold criterion has been satisfied.

14. The system of claim 8, wherein the first process is a consumer process that performs one or more operations based on data values in the first entry of the queue.

15. A system comprising:
a first processor;
a second processor; and
processing circuitry coupled to the first processor and the second processor, the processing circuitry to:
provide a first entry of a queue to the first processor, wherein the queue comprises a plurality of segments;
provide a second entry of the queue to the second processor;
responsive to receiving a first signal from the first processor, modify a data structure associated with the queue for the first entry, wherein the data structure associated with the queue comprises a plurality of sections, wherein each section comprises one or more counters each associated with a segment of the plurality of segments, and wherein to modify the data structure associated with the queue for the first entry, the processing circuitry is to increment a first counter;
responsive to receiving a second signal from the second processor, modify the data structure associated with the queue for the second entry, wherein to modify the data structure associated with the queue for the second entry, the processing circuitry is to increment a second counter; and
modify a tail pointer of the queue based on the data structure associated with the queue.

16. The system of claim 15, wherein:
the first entry is in a first segment of the plurality of segments;
the first counter is associated with the first segment of the plurality of segments;
the second entry is in a second segment of the plurality of segments; and
the second counter is associated with the second segment of the plurality of segments.

17. The system of claim 16, wherein to modify the tail pointer of the queue based on the data structure associated with the queue, the processing circuitry is to, responsive to a particular counter satisfying a threshold criterion, modify the tail pointer of the queue to equal an end of a particular segment associated with the particular counter.

18. The system of claim 17, wherein the processing circuitry is further to determine that a head pointer of the queue and the tail pointer point to a same segment of the queue, wherein to modify the tail pointer of the queue based on the data structure associated with the queue, the processing circuitry is to, responsive to a counter corresponding to the same segment of the queue satisfying a partial advance criterion, modify the tail pointer of the queue to equal a position of the head pointer.

19. The system of claim 16, wherein a first section of the plurality of sections comprises a tail indicator bit, one or more tail address bits, the first counter, and the second counter.

20. The system of claim 17, wherein the first counter and the second counter each have a guard bit to indicate whether the threshold criterion has been satisfied.
